(19) United States
(12) Patent Application Publication
(10) Pub. No.: US 2008/0177098 A1
(43) Pub. Date: Jul. 24, 2008

(54) PROCESS FOR THE PREPARATION OF METAL-ORGANIC FRAMEWORKS

(76) Inventors: Stefan Bahnmuller, Koln (DE); Gerhard Langstein, Kurten (DE); Roland A. Fischer, Bochum (DE); Stephen Hermes, Bochum (DE)

Correspondence Address: NORRIS, MCLAUGHLIN & MARCUS, P.A., 875 THIRD AVE, 18TH FLOOR, NEW YORK, NY, 10022, US

(21) Appl. No.: 11/870,611

(22) Filed: Oct. 11, 2007

(30) Foreign Application Priority Data
Oct. 11, 2006 (DE) 102006048043.0

(51) Int. Cl. C07F 3/06

(52) U.S. Cl. 556/118

(57) ABSTRACT

Process for the preparation of nanoscale metal-organic frameworks, and porous frameworks synthesized from at least one metal ion and at least one at least bidentate organic compound and a monodentate growth inhibitor.

The invention relates to a process for the preparation of nanoscale, porous metal-organic frameworks by the use of crystal growth inhibitors that also prevent agglomeration.

The invention further relates to a framework material optionally having reactive functional groups that enable coupling reactions with other compounds.

### BACKGROUND OF THE INVENTION

Crystalline, porous metal-organic frameworks (MOF) are known per se. One reference to this is the scientific publication by Yaghi et al. in Microporous and Mesoporous Materials, volume 73, number 1-2, pp 3-14, which summarizes the current state of knowledge. Possible applications of the frameworks as gas accumulators (H₂, CH₄) for miniaturized fuel cells, as gas sensors and as separating media and catalytic materials are also described.

Some current strategies for synthesizing metal-organic frameworks are designed for obtaining macroscopic crystals of the frameworks (cf, for example, U.S. 2003078311) so as to be able to characterize them completely as a pure phase. Other approaches show more rapid reaction pathways leading to pulverulent framework material, although, at ˜700 m²/g, this cannot achieve the high surface areas of up to 3000 m²/g (determined according to the Langmuir model) of the crystalline MOFs.

The synthesis of nanoscale metal-organic frameworks has only been mentioned by Yan et al. in Microporous and Mesoporous Materials, volume 58, pp 105-114, the formation of the framework material being supported by non-ionic surfactants, e.g. polyoxyethylene(4) lauryl ether (Brij 30). The MOF particles formed, which are in the 100 nm region, are not protected from agglomeration, so they can coalesce after they have formed.

One of the objects of the present invention is therefore to provide a process for the specific synthesis of nanoscale frameworks, i.e. frameworks having maximum particle diameters of up to 500 nm, especially of up to 200 nm and particularly preferably of up to 100 nm.

The frameworks should preferably be protected from agglomeration and particularly preferably be redispersible. Furthermore, the frameworks should be capable of undergoing coupling reactions with other chemical compounds, especially via functional groups.

### SUMMARY OF THE INVENTION

The object is achieved by a process for the preparation of metal-organic frameworks having maximum particle diameters of up to 500 nm, preferably up to 200 nm and particularly preferably up to 100 nm, Wherein a solution containing metal ions is mixed with a bidentate or multidentate ligand compound to form metal-ligand complexes, the solution is then heated to initiate crystal growth All the solid particles having a diameter of >20 nm, preferably of >10 nm, are separated off, the solution is then cooled rapidly, especially at a rate of at least 10 K/min preferably of at least 30 K/min, to a pre-determined minimum temperature, preferably room temperature, the particle size of the frameworks present in the solution is monitored, preferably by means of light scattering measurement, and a growth inhibitor, preferably a monodentate ligand, is added to the solution on reaching the desired particle size in the range of up to 500 nm, preferably up to 200 nm and particularly preferably up to 100 nm.

### DETAILED DESCRIPTION

The metal ions are in particular metal ions of an element of group Ia, IIa, IIIa, IV-VIIIa or Ib-VIb of the Periodic Table of the Elements, zinc, copper, iron, aluminum, chromium, nickel, palladium, platinum, ruthenium, rhenium and cobalt being preferred and Zn²⁺ being particularly preferred.

In principle, the at least bidentate organic ligand compound suitable for coordination with the metal ions can be any of the compounds that are suitable for this purpose and satisfy the above conditions. The at least bidentate organic ligand compound must in particular have at least two centers capable of forming a bond with the metal ions of a metal salt, especially with the metals of the aforesaid groups Ia, IIa, IIIa, IV-VIIIa and Ib-VIb.

Said at least bidentate organic ligand compounds can be selected especially from substituted or unsubstituted, mononuclear or polynuclear aromatic dicarboxylic acids and substituted or unsubstituted, mononuclear or polynuclear aromatic dicarboxylic acids having at least one heteroatom. Particularly preferred examples which may be mentioned specifically are dicarboxylic acids of benzene, naphthalene, pyridine or quinoline,

Here and below, unless specifically mentioned otherwise, substituted is understood in particular as meaning substitution with halogen, especially F, Br or 1, with —CF₃, —OH, —NH₂ or —CHO, with a C₁- to C₆-alkyl, C₁- to C₆-alkenyl, C₁- to C₆-alkynyl or C₁- to C₆-alkoxy group or with a thiol, sulfonate, ketone, aldehyde, epoxy, silyl or nitro group.

In one preferred process, the solvent used is water, methanol, ethanol, dimethylformamide, diethylformamide, chlorobenzene, N-methylpyrrolidone or a mixture of two or more of these solvents.

Suitable growth inhibitors, especially monodentate ligand growth inhibitors, are substituted or unsubstituted alkylcarboxylic acids, substituted or unsubstituted, mononuclear or polynuclear aromatic carboxylic acids and substituted or unsubstituted, mononuclear or polynuclear aromatic carboxylic acids having at least one heteroatom.

The following particularly preferred monodentate ligand growth inhibitors may be mentioned specifically: monocarboxylic acids of benzene, naphthalene, pyridine or quinoline and derivatives thereof.

The monodentate growth inhibitor benzoic acid or a benzoic acid derivative is particularly preferred.

In particular, a benzoic acid derivative having a functional group in the ortho, meta or para position, particularly preferably in the para position, is especially preferred.

Suitable functional groups are hydrogen hydroxyl amines, halogens, linear or optionally cyclic, substituted or unsubstituted C₁- to C₆-alkyl, C₁- to C₆-alkenyl, C₁- to C₆-alkynyl or C₁- to C₆-alkoxy groups or thiol, sulfonate, phosphine, ketone, aldehyde, epoxy, silyl or nitro groups.

Particularly preferred functional groups are hydrogen, —CF₃, vinyl, hydroxyl or ethoxy.

In one especially preferred embodiment of the process, the benzoic acid derivative is selected from the group consisting of benzoic acid, para-trifluoromethylbenzoic acid, para-vinylbenzoic acid, para-hydroxybenzoic acid and para-ethoxybenzoic acid.

The invention also provides metal-organic frameworks having maximum particle diameters of up to 500 nm, preferably of up to 200 nm and particularly preferably of up to 100 nm, having sit least one metal ion and at least one at least bidentate organic ligand compound and a monodentate growth inhibitor, obtainable by one of the aforementioned processes.

A preferred framework is characterized in that it has a mean particle diameter of 1-150 nm, preferably of 10-100 nm and particularly preferably of 20-60 nm.

The nanoscale metal-organic frameworks according to the invention are prepared e.g. by the following procedure:

Firstly, a metal salt is dissolved in a solvent or solvent mixture and an at least bidentate organic compound is added, preferably with constant stirring. As soon as the solution is homogeneous, it is heated initially to a temperature of 40 to 90° C., preferably to a temperature of between 60 and 70° C., in a closed reaction vessel. The resulting MOF stock solution is left to stand for between 1 and 150 hours at this temperature before being heated in a second phase to a minimum of 80-100° C. for a further 1-24 hours. The crystal growth process begins at the latter temperature range. The stock solution is then separated from solid particles by filtering particles with a size >20 nm. The stock solution is then cooled rapidly, preferably to room temperature. The MOF crystals which are formed must then be separated from the solution, by e.g. centrifugation, filtration or membrane filtration.

The size of the particles in the separated homogeneous solution is monitored and. when a predetermined particle diameter is reached, which preferably occurs within 0.5 minutes to 1 hour, a monodentate growth inhibitor is added. The resulting nanoparticles of metal-organic framework can then be separated off by removal of the solvent at elevated temperature and preferably at reduced pressure, and the pores contained therein can be emptied as well.

The invention also provides for the use of the frameworks according to the invention as gas accumulators (especially for storing hydrogen and methane) for miniaturized fuel cells, as gas sensors and as separating media and catalytic materials.

### EXAMPLES

### Example 1

3.14 g of Zn(NO₃)₂·4H₂O are placed in a sealable glass vessel and dissolved in 100 ml of DEF, with vigorous stirring. 0.57 g of terephthalic acid is added to the homogeneous solution and likewise dissolved, with stirring. The vessel is sealed and the homogenized solution is heated at 65° C. for 72 hours in the sealed glass vessel. The temperature is then raised to 90° C. for 90 minutes. Using a Teflon membrane, the solution is filtered while still hot and 5 ml of the filtered solution are transferred to a glass cuvette, and rapidly cooled to room temperature in a water bath. The growth of colloidal MOF-5 particles is monitored by time-resolved static light scattering. When the particles reach a radius of 100 nm (gyration radius), a solution of 0.76 g of perfluoromethylbenzoic acid in one millilitre of DEF is added, Thorough homogeneous mixing is effected by swirling. The MOF colloids thereby obtained have a maximum particle size of 100 nm.

### Example 2

3.14 g of Zn(NO₃)₂·4H₂O are placed in a sealable glass vessel and dissolved in 100 ml of DEF, with vigorous stirring. 0.57 g of terephthalic acid is added to the homogeneous solution and likewise dissolved, with stirring. The vessel is scaled and the homogenized solution is heated at 65° C. for 72 hours in the sealed glass vessel. The temperature is then raised to 90° C. for 90 minutes. Using a Teflon membrane, the solution is filtered while still hot and 5 ml of the filtered solution are transferred to a glass cuvette, and rapidly cooled to room temperature in a water bath. The growth of colloidal MOF-5particles is monitored by time-resolved static light scattering. When the particles reach a radius of 100 nm (gyration radius), a solution of 0.59 g of vinylbenzoic acid in one millilitre of DES is added. Thorough homogeneous mixing is effected by swirling. The MOF colloids thereby obtained have a maximum particle size of 100 nm.

1. Process for the preparation of metal-organic frameworks having maximum particle diameters of 500 nm, wherein a solution containing metal ions is mixed with a bidentate or multidentate ligand compound to form metal-ligand complexes, the solution is heated to initiate crystal growth, then all resulting solid particles having a diameter of >20 nm are separated off, the solution is cooled at a rate of at least 10 K/min, the particle size of the frameworks present in the solution is monitored, and a growth inhibitor is added to the solution on reaching a particle size in the range of up to 500 nm.

2. Process according to claim 1, wherein said maximum particle size is up to 200 nm.

3. Process according to claim 2, wherein said maximum particle size is up to 100 nm.

4. Process according to claim 1, wherein said solution is cooled at a rate of at least 30 K/min.

5. Process according to claim 1, wherein said monitoring of said particle size is by light scattering measurement.

6. Process according to claim 1, wherein said growth inhibitor is a monodentate ligand.

7. Process according to claim 1, wherein said growth inhibitor is added to said cooled solution upon reaching a particle size of up to 200 nm.

8. Process according to claim 7, wherein said growth inhibitor is added to said cooled solution upon reaching a particle size of up to 100 nm.

9. Process according to claim 1, wherein the metal ion is an ion of an element selected from the group consisting of zinc, copper, iron, aluminum, chromium, nickel, palladium, platinum, ruthenium, rhenium and cobalt.

10. Process according to claim 9, wherein said metal ion is Zn²⁺

11. Process according to claim 1 wherein the at least bidentate organic ligand compound is a substituted or unsubstituted, mononuclear or polynuclear aromatic dicarboxylic acid or a substituted or unsubstituted, mononuclear or polynuclear aromatic dicarboxylic acid having at least one heteroatom wherein, when substituted, said compounds are substituted with substituents selected from the group consisting of halogen, —CF₃, —OH, —NH₂, —CHO, C₁- to C₆-alkyl, C₁- to C₆-alkenyl, C₁- to C₆-alkynyl or C₁- to C₆-alkoxy groups, and thiol, sulfonate, ketone, aldehyde, epoxy, silyl and nitro groups.

12. Process according to Claim 11, wherein said at least bidentate organic ligand compound is a dicarboxylic acid of benzene, naphthalene, pyridine or quinoline.

13. Process according to claim 12, wherein the at least bidentate organic ligand compound is terephthalic acid.

14. Process according to claim 1, wherein the monodentate growth inhibitor is an alkylcarboxylic acid that is unsubstituted or substituted by functional groups, a mononuclear or polynuclear aromatic carboxylic acid that is unsubstituted or substituted by functional groups, or a mononuclear or polynuclear aromatic carboxylic acid that has at least one heteroatom and is unsubstituted or substituted by functional groups.

15. Process according to claim 14, wherein the monodentate growth inhibitor is benzoic acid or a benzoic acid derivative.

16. Process according to claim 15, wherein the benzoic acid derivative has a functional group in the ortho, meta or para position.

17. Process according to claim 16, wherein said functional group is in the para position.

18. Process according to claim 14, wherein said functional groups are selected from the group consisting of hydrogen, hydroxyl, amines, halogens, linear or optionally cyclic, substituted or unsubstituted C₁- to C₆-alkyl, C₁- to C₆-alkenyl, C₁- to C₆-alkynyl or C₁- to C₆-alkoxy groups thiols, sulfonates, phosphines, ketones, aldehydes, epoxys, silyls and nitro groups.

19. Process according to claim 18, wherein said functional groups are selected from the group consisting of hydrogen, CF₃, vinyl, hydroxyl and ethoxy.

20. Process according to claim 19, wherein the benzoic acid derivative is selected from the group consisting of benzoic acid, para-trifloromethylbenzoic acid, para-vinylbenzoic acid, para-hydroxybenzoic acid and para-ethoxybenzoic acid.

21 Process according to claim 1, wherein the solvent for said solution is selected from the group consisting of water, methanol, ethanol, dimethyl-formamide, diethylformamide, chlorobenzene, N-methylpyrrolidone and mixtures of two or more thereof.

22. Metal-organic framework having a maximum particle size of up to 500 nm, having at least one metal ion, at least one at least bidentate organic ligand compound and a monodentate growth inhibitor, obtained by the process of claim 1.

23. Metal-organic framework according to claim 22, wherein said maximum particle size is up to 200 nm.

24. Metal-organic framework according to claim 23, wherein said maximum particle size is up to 100 nm.

25. Metal-organic framework according to claim 22, having a mean particle diameter of 1-150 nm.

26. Metal-organic framework according to claim 25, wherein said mean particle diameter is 10-100 nm.

27. Metal-organic framework according to claim 25, wherein said mean particle diameter is 20-60 nm.

28. Gas accumulators for miniaturized fuel cells, gas sensors, separating media, and catalytic materials comprising the Metal-organic framework of claim 22.
